(19) United States
(12) Patent Application Publication
(10) Pub. No.: US 2009/0124733 A1
(43) Pub. Date: May 14, 2009

(54) Flame retardant polybutylene terephthalate resin composition

(75) Inventors: Jun Haruhara, Shizuoka (JP); Takakazu Hirakawa, Shizuoka (JP); Kazuhito Hanabusa, Shizuoka (JP)

Correspondence Address: BUCHANAN, INGERSOLL & ROONEY PC, POST OFFICE BOX 1404, ALEXANDRIA, VA, 22313-1404, US

(73) Assignee: WinTech Polymer Ltd., Tokyo (JP)

(21) Appl. No.: 11/991,380

(22) PCT Filed: Sep. 25, 2006
(86) PCT No.: PCT/JP2006/319617

§ 371 Date: Mar. 3, 2008

(30) Foreign Application Priority Data
Sep. 28, 2005 (JP) 2005-282509

(51) Int. Cl. C08K 5/5313; C08K 5/3492

(52) U.S. Cl. 524/100; 524/133; 524/502

(57) ABSTRACT

The invention provides a resin composition which gained flame-retardancy by a non-halogen based flame-retardant, having excellent small-warping performance without deteriorating excellent moldability and various characteristics (mechanical characteristics, electrical characteristics, and long-term environmental characteristics) which are inherent advantageous properties of polybutylene terephthalate resin. Specifically, to (A) 100 parts by weight of polybutylene terephthalate-based resin, there are mixed: (B) 10 to 100 parts by weight of a polymer of one or more types selected from the group consisting of modified polyester and styrene-based resin; (C) 10 to 100 parts by weight of specific phosphinic acid salt and/or diphosphinic acid salt and/or a polymer thereof; and (D) 20 to 200 parts by weight of glass fiber having an average cross-sectional area ranging from 100 to 300 square micrometers.

### TECHNICAL FIELD

The present invention relates to a flame-retardant polybutylene terephthalate resin composition having an excellent flame-retardancy and small-warping performance without using a halogen-based flame-retardant, and to a molding using it, and specifically relates to a flame-retardant polybutylene terephthalate resin composition having excellent flame-retardancy, good mechanical characteristics, and moldability, and also having an excellent appearance, small metal-contamination, good electrical characteristic (tracking resistance), and small-warping performance, and to a molding using it.

### BACKGROUND ART

Thermoplastic polyester resins are widely used including electrical and electronic parts and automobile parts owing to their excellent characteristics. Particularly in the fields of electrical and electronic equipment, they are often used after being provided with flame-retardancy to assure safety measures against flaming. To provide the thermoplastic polyester resins with flame-retardancy, halogen-based flame-retardants such as halogen compound and antimony compound are generally applied. These types of halogen-based flame-retardants, however, generate dioxin compounds during combustion and decomposition of the flame-retardants in some cases, which is not preferred in view of environmental issues. To these issues, the European Union effectuated the RoHS (the restriction of the use of certain hazardous substances in electrical and electronic equipment) Directive which prohibits the use of specified bromine-based flame-retardants, and the WEEE (waste electrical and electronic equipment) Directive which commands the classification and treatment of plastics containing any kind of bromine-based flame-retardants. With the legal directives, there has been increasing the necessity of non-halogen plastics for the electrical and electronic equipment. There are similar movements, in a part, even in what is called the Eco-Label called Blue Angel, Nordic Swan and the like and there is also a severer request for prohibiting the halogen-based flame-retardants than the above Directives. Responding to the movements, the OA equipment parts which have been emphasized to acquire the Eco-Label are requested to be non-halogen parts before the occurrence of the request for the electrical and electronic parts.

To solve the above problem, there have been attempts to improve the flame-retardancy by adding red phosphorus and phosphoric acid compound as the non-halogen-based flame-retardant, (such as JP-B 5-18356 and JP B-62-25706). Use of those flame-retardants, however, cannot attain satisfactory improvement effect of flame-retardancy of thermoplastic polyester resins. To acquire the V-0 rank of UL with sole polyester, the addition of a large amount of flame-retardant is required, which raises problems of deteriorating in strength and generation of bleed-out of flame-retardant.

To solve the above problems, there have been provided the methods of attaining further high flame-retardancy by the addition of a composition of thermoplastic polyester resin and red phosphorus or phosphoric acid to polymers such as polycarbonate or polyphenylene ether having self-extinction performance, or being difficult to thermally decompose and having high oxygen index, (such as JP-A 11-236496 and JP-A 9-132723). Even with the disclosed technology, however, there arise problems in that the molding being subjected to a long period of heating generates compounds such as phosphoric acid as the decomposed substance coming from the flame-retardant, and generating compounds contaminate the surrounding metal-contacts, thus losing the insulation performance that the molding should inherently have.

Furthermore, JP-A 8-73720 provides a method of using a specified calcium phosphinate salt or aluminum phosphinate salt. That type of compound, however, requires the addition of large amounts to attain good flame-retardancy, and causes problem of deterioration in moldability and of mechanical characteristics.

With this view, JP-A 11-60924 provides a method of adding certain amounts of nitrogen-containing organic compounds (such as melamine cyanulate) to a certain amount of specific phosphinic acid salt or calcium or aluminum salt of diphosphinic acid. Although that type of compound significantly improves the flame-retardancy, it is still difficult to stably attain the V-0 rank on a molding having a thickness of 1 mm or less. Furthermore, there is a most serious problem. That is, even when slow-burning resins such as modified polyester and styrene-based resin are added for providing the polyester with the functions of small-warping performance and impact resistance by utilizing the above technology, the flame-retardancy cannot be improved and further the flame-retardancy largely deteriorates because these polymers are more likely to thermally decompose and have a small oxygen index. When the above-described polymers, such as polycarbonate and polyphenylene ether, having self-extinction performance, or being difficult to thermally decompose and having high oxygen index, is added, there arise problems of deterioration in toughness, deterioration in tracking resistance, and significant yellowing, though some degree of flame-retardancy and small-warping performance can be attained.

### DISCLOSURE OF THE INVENTION

As described above, without deteriorating moldability and various characteristics (mechanical characteristics, electrical characteristics, and long-term environmental characteristics) of resin, it is very difficult to attain both high flame-retardancy and small-warping performance by alloying a polybutylene terephthalate resin with a slow-burning polymer through the conventional method.

In this regard, the present invention provides a polybutylene terephthalate resin composition having excellent small-warping performance by letting the resin have flame-retardancy with the addition of a non-halogen-based flame-retardant, without deteriorating the excellent moldability and various characteristics (mechanical characteristics, electrical characteristics, and long-term environmental characteristics) of polybutylene terephthalate resin, and to provide moldings or molded articles (electrical and electronic parts, OA equipment parts, and the like) manufactured by the polybutylene terephthalate resin composition.

The present invention further provides a non-halogen-based flame-retardant polybutylene terephthalate resin composition which keeps V-0 rank in UL Standard UL 94, preferably keeps V-0 rank even at a thickness of 1 mm or less, has high flame-retardancy, and also keeps insulation performance without inducing bleed-out in high-temperature environments, and further has high tracking resistance and small-warping performance, and provides a molding manufactured by the non-halogen-based flame-retardant polybutylene terephthalate resin composition.

Through keen examination conducted by the inventors of the present invention, it was found that, on attaining flame-retardancy by adding a specific phosphinic acid salt and/or a specific diphosphinic acid salt to an alloy of a polybutylene terephthalate and a specific slow-burning polymer, the addition of glass fiber which has a specific cross-sectional area remarkably improves the flame-retardancy, thus attaining flame-retardancy and small-warping performance at high levels while maintaining the moldability and various characteristics (mechanical characteristics, electrical characteristics, and long-term environmental characteristics) thereof, and the present invention has been achieved.

That is, the present invention provides a flame-retardant polybutylene terephthalate resin composition comprising: (A) 100 parts by weight of a polybutylene terephthalate-based resin; (B) 10 to 100 parts by weight of one or more types of polymer selected from a modified polyester and a styrene-based resin; (C) 10 to 100 parts by weight of a phosphinic acid salt expressed by the formula (1) and/or a diphosphinic acid salt expressed by the formula (2) and/or a polymer thereof; and (D) 20 to 200 parts by weight of glass fiber having 100 to 300 square micrometers of the average cross-sectional area,

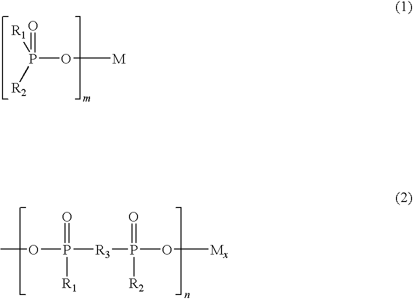

(where R₁ and R₂ are each a straight-chain or branched-chain C₁ to C₆ alkyl or phenyl, R₃ is a straight-chain or branched-chain C₁ to C₁₀ alkylene, arylene, alkylarylene or arylalkylene, M is calcium ion or aluminum ion, m is 2 or 3, n is 1 or 3, and X is 1 or 2.)

The present invention provides electrical or electronic parts or OA equipment parts being manufactured by injection molding of the above flame-retardant polybutylene terephthalate resin composition. The present invention also provides uses of the above flame-retardant polybutylene terephthalate resin composition in electrical or electronic parts or OA equipment parts.

### DETAILED DESCRIPTION OF THE INVENTION

As described above, when using electrical or electronic parts or OA equipment parts, excellent small-warping performance, flame-retardancy, and electrical characteristics have to be maintained. The flame-retardant polybutylene terephthalate resin composition according to the present invention can achieve these required characteristics at high levels. Therefore, the flame-retardant polybutylene terephthalate resin composition of the present invention is suitable for various types of electrical and electronic parts and OA equipment parts which request large size and strong asymmetry, or high dimensional accuracy. Examples of these parts for use in OA equipment parts are parts guide, paper guide, and gear housing in copying machine and printer. Examples of these parts for use in electrical and electronic parts are chassis for optical recording media and terminal table of electronic parts.

Detailed description about the components of the resin composition according to the present invention is given below. First, the polybutylene terephthalate-based resin (A) as the base resin of the present invention is a polymer composed mainly of a dicarboxylic acid compound or an esterifiable derivative thereof, and a diol or an esterifiable derivative thereof. The polybutylene terephthalate-based resin (A) is obtained by polycondensation reaction. The dicarboxylic acid component in the polybutylene terephthalate is a terephthalic acid unit, and the diol component therein is a tetramethylene glycol unit. It is required that the amount of the terephthalic acid component is more than 90% by mole based on the amount of the total acid components, and that the alkylene glycol component is more than 90% by mole based on the amount of the total diol components.

The polybutylene terephthalate may copolymerize, within a range of less than 10% by mole based on the total amount of the acid components, at least one acid component selected from, for example, 2,6-naphthalene dicarboxylic acid, 2,7-naphthalene dicarboxylic acid, 1,5-naphthalene dicarboxylic acid, 1,7-naphthalene dicarboxylic acid, isomers of other types of naphthalene dicarboxylic acids, aromatic dicarboxylic acids such as isophthalic acid, diphenyl dicarboxylic acid, diphenoxyethane dicarboxylic acid, diphenyl ether dicarboxylic acid or diphenylsulfone dicarboxylic acid, alicyclic dicarboxylic acids such as hexahydro terephthalic acid or hexahydro isophthalic acid, aliphatic dicarboxylic acids such as adipic acid, sebacic acid or azelaic acid, and bifunctional carboxylic acids containing oxy acids such as p-β-hydroxy ethoxybenzoic acid or ε-oxycaproic acid.

According to the present invention, any of the polybutylene terephthalate-based reins prepared by polycondensation using the above compounds as the monomer components can be used as the component (A) of the present invention, and they may be used separately or in combination of two or more of them.

Applicable polybutylene terephthalate-based resin used in the present invention has an intrinsic viscosity within a range of 0.5 to 1.3 dl/g. From the point of moldability and mechanical characteristics, a preferable range of the intrinsic viscosity is from 0.65 to 1.1 dl/g. The resin having less than 0.5 dl/g of intrinsic viscosity extremely deteriorates the mechanical strength, while the resin having greater than 1.3 dl/g of intrinsic viscosity deteriorates the flowability resulting in poor moldability.

The components (B) used as alloying counterparts to polybutylene terephthalate-based resin (A) as the base resin in the present invention are one or more of polymers selected from modified polyester and styrene-based resin, that is, normally slow-burning resins being added to provide small-warping performance that cannot be attained by sole polybutylene terephthalate resin.

As of the components (B) used in the present invention, the modified polyester includes an acid-modified polyester containing less than 90% by mole of the terephthalic acid component to the total amount of the acid components, a glycol-modified polyester containing less than 90% by mole of the alkylene glycol component to the total amount of the diol components and the like. Examples of them are an isophthalic acid-modified polybutylene terephthalate in which 15% by mole to the total amount of acid components is modified to the isophthalic acid, an isophthalic acid-modified polyethylene terephthalate, and a modified polyethylene terephthalate in which 30% by mole to the total amount of diol components is modified to the cyclohexane diol. In addition, there can be applied a modified polyester obtained by copolymerizing polybutylene terephthalate with other components by an amount of 10% or more, such as a poly(ester-ether)elastomer obtained by copolymerizing polybutylene terephthalate unit with 100% by mole of polytetramethylene glycol, and a poly(ester-ether)elastomer obtained by copolymerizing polybutylene terephthalate unit with 100% by mole of polycaprolactone.

As of the components (B) used in the present invention, the styrene-based resin includes a polymer and a copolymer which contain a repeated unit derived from an aromatic vinyl compound. Examples of the aromatic vinyl compound are styrene, α-alkyl-substituted styrene, and nuclei-alkyl-substituted styrene. Examples of monomer other than the aromatic vinyl compound are acrylonitrile and methyl methacrylate. The styrene-based resin may be the one which is modified by rubber. Examples of the rubber are polybutadiene, styrene-butadiene copolymer, polyisoprene, and ethylene-propylene copolymer. The styrene-based resin may be an epoxy-modified one. Specific examples of such styrene-based resins are polystyrene, rubber-modified polystyrene, ABS resin, MBS resin, AS resin, and ESBS resin. As of these, preferred ones are ABS resin, AS resin, ESBS resin, and a mixture of them.

When slow-burning polymers other than above are used as the components (B), simultaneous attainment of sufficient strength, flame-retardancy, and small-warping performance becomes difficult. Furthermore, when self-extinguishing resins other than above are used as the components (B), such as polycarbonate, polyphenylene ether, and novolac resin, it is difficult to attain both satisfactory strength and tracking resistance even if flame-retardancy and small-warping performance can be obtained.

According to the present invention, any of these components (B) is blended by amounts from 10 to 100 parts by weight to 100 parts by weight of the polybutylene terephthalate-based resin (A). If the blending amount is less than 10 parts by weight, the small-warping performance as the object cannot fully be attained. If the blending amount is greater than 100 parts by weight, the characteristics of polybutylene terephthalate as the base resin deteriorate, thus failing to maintain the sophisticated flame-retardancy which is the object of the present invention.

The compound used as the component (C) in the present invention is a phosphinic acid salt expressed by the formula (1) and/or a diphosphinic acid expressed by the formula (2) and/or a polymer thereof.

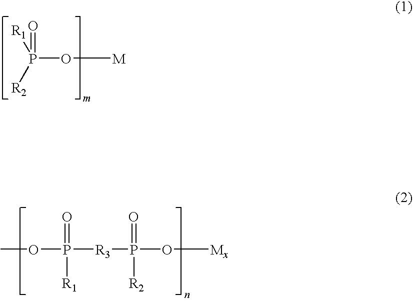

(where R₁ and R₂ are each a straight-chain or branched-chain C₁ to C₆ alkyl or phenyl, R₃ is a straight-chain or branched-chain C₁ to C₁₀ alkylene, arylene, alkylarylene, or arylalkylene, M is calcium ion or aluminum ion, m is 2 or 3, n is 1 or 3, and X is 1 or 2.)

According to the present invention, one or more of these compounds are used. The compound (C) in the present invention can be added by an amount from 10 to 100 parts by weight to 100 parts by weight of the component (A). If the added amount is less than 10 parts by weight, the obtained flame-retardancy becomes insufficient. If the added amount is greater than 100 parts by weight, the mechanical characteristics deteriorate and the materials cost becomes excessively high, which is not practical. From the viewpoint of both the flame-retardancy and the mechanical characteristics, a preferred range to be added is from 20 to 90 parts by weight.

The glass fiber (D) used in the present invention has an average cross-sectional area within a range of 100 to 300 square micrometers. Within the range of the cross-sectional area, two or more kinds of glass fiber may be used together. If the average cross-sectional area is less than 100 square micrometers, the flame-retardancy extremely deteriorates. If the cross-sectional area is greater than 300 square micrometers, sufficient reinforcement effect which is an object of the present invention cannot be attained. A preferable range of the cross-sectional area to attain both the flame-retardancy and the reinforcement effect is from 140 to 300 square micrometers.

The glass fiber (D) can be in any cross-sectional shape as far as the average cross-sectional area is within the above range. The cross section may be in the ordinary shape of a near-circle, but it is preferably in a flat shape, specifically cocoon shape, oblong shape, elliptical shape, semicircle shape, arc shape, rectangular shape, or a similar shape to them. To further improve the small-warping performance and the strength as the functionality of the present invention, it is preferred that the ratio of the longer diameter (major axis) on cross section perpendicular to the longitudinal direction (the longest linear distance across the section) to the shorter diameter (minor axis) (the longest linear distance perpendicular to the longer diameter) is within a range of 1.3 to 10, more preferably 1.5 to 5, and most preferably 2 to 4.

Although the length of the glass fiber (D) is arbitrary, shorter length is preferable to decrease the deformation of the molding, considering the balance of the mechanical properties and the deformation of the molding. From the viewpoint of mechanical strength, the average fiber length is preferably longer one, at least 30 μm. Normally the length of the glass fiber (D) is determined responding to the required performance. Normally, 50 to 1000 μm of the fiber length is preferred.

On using the glass fiber (D), it is preferred, if necessary, to use a converging agent or a surface-treating agent. Examples of converging agent and surface-treating agent are functional compounds such as epoxy-based compound, isocyanate-based compound, silane-based compound or titanate-based compound. Those compounds may be subjected to surface treatment or convergence treatment in advance, or may be added at the time of the preparation of materials.

The glass fiber (D) used in the present invention is prepared by spinning through a nozzle having adequate hole shapes such as a circular shape, an oblong shape, an elliptical shape, a rectangular shape, and slit, as the bushing for injecting molten glass. Alternatively, the glass fiber (D) can be prepared by spinning molten glass through pluralities of nozzles; having various cross-sectional shapes (including circular cross section), arranged closely each other, and then by joining the spun molten glass together to obtain monofilaments.

The blending amount of the glass fiber (D) used in the present invention is within a range of 20 to 200 parts by weight to 100 parts by weight of the polybutylene terephthalate (A), and more preferably from 30 to 130 parts by weight. If the weight parts are less than 20, the desired reinforcement effect cannot be attained. If the weight parts are greater than 200, the molding work becomes difficult. The use amount of the functional surface-treating agent is within a range of 0 to 10% by weight to the amount of glass fiber, and preferably 0.05 to 5% by weight.

The composition according to the present invention shows V-0 grade in UL Standard UL 94, preferably shows V-0 grade even at the thickness of the molding at 1 mm or less.

According to the present invention, a salt of triazine-based compound, and cyanulic acid or isocyanulic acid as the component (E) can be added in order to complement the flame-retardancy and to decrease the cost. An example of preferred component (E) is a salt of the triazine-based compound expressed by the formula (3) and cyanulic acid or isocyanulic acid.

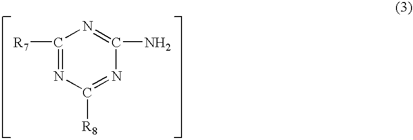

(where R₇ and R₈ are each hydrogen atom, amino group, aryl group, or C₁ to C₃ oxyalkyl group, and R₇ and R₈ may be the same each other or different from each other.)

According to the present invention, a specifically preferred component (E) is melamine cyanulate in terms of flame-retardancy, stability, and cost.

According to the present invention, the blending amount of the salt of triazine-based compound (E) and cyanulic acid or isocyanulic acid is 5 to 50% by weight to the sum of the component (C) and the component (E), and blending amount of the sum of the component (C) and the component (E) is 10 to 100 parts by weight to 100 parts by weight of the component (A). The blending amount of greater than 50% by weight to the sum of the component (C) and the component (E) is unfavorable because the mold-deposit becomes significant, and further flame-retardancy and moldability deteriorate. If the blending amount is less than 5% by weight, the effect to decrease the cost is not attained, though there appears no significant effect from a technological point of view. A preferred amount of the component (E) in the present invention is determined by the adjustment of flame-retardancy and cost in relation to the component (C). More preferably, the blending amount is within a range of 15 to 40% by weight to the sum of the component (C) and the component (E), and the sum of the component (C) and the component (E) is within a range of 20 to 90 parts by weight to 100 parts by weight of the component (A).

The resin composition according to the present invention can further contain the commonly known substance which is generally added to thermoplastic resins and the like in order to provide a desired characteristic responding to the object, within a range not to deteriorate the effect of the present invention. For example, there can be added antioxidant, UV absorber, stabilizers such as light-stabilizer, antistatic agent, lubricant, releasing agent, coloring agents such as dye and pigment or plasticizer. In particular, the addition of antioxidant and releasing agent is effective to improve the heat-resistance.

Examples of the antioxidants suitable for the present invention are organic phosphite-based compound, phosphite-based compound, and metal salt of phosphoric acid, and specifically bis(2,4-di-tert-4-methylphenyl)pentaerythritol diphosphite, bis(2,4-di-tert-butylphenyl)pentaerythritol diphosphite, and terakis(2,4-di-tert-butylphenyl)-4,4′-biphenylene phosphite. Examples of the metal salt of phosphoric acid are mono-hydrate of calcium primary phosphate and sodium primary phosphate. In addition to those compounds, hindered phenol-based antioxidant may be added.

Releasing agents suitable for the present invention are ester or part-ester of higher fatty acid and polyhydric alcohol, and polyolefin wax, specifically pentaerythritol stearic acid ester, glycerin fatty acid ester, sorbitan fatty acid ester, montanic acid ester, and low-molecular-weight polyethylene wax.

The addition of a compound to inhibit the dripping of molten droplets during combustion may be applied. Such compounds include polytetrafluoroethylene prepared by emulsion polymerization and fumed colloidal silica.

The blending amount of the antioxidant, the releasing agent, and the compound to inhibit dripping droplets is within a range of 0.005 to 3.0 parts by weight, preferably from 0.01 to 1.5 parts by weight, respectively, to 100 parts by weight of the component (A). If the blending amount is less than 0.005 parts by weight, the improving effect is small. If the blending amount is greater than 3.0 parts by weight, the appearance of molding deteriorates owing to the bleeding onto the surface of the molding, and insufficient dispersion results, which is unfavorable.

According to the present invention, other inorganic fillers can be added within a range not to deteriorate the effect of the present invention. More specifically, carbon fiber, wollastonite, potassium titanate, calcium carbonate, titanium oxide, feldspar-group mineral, clay, organized clay, white carbon, carbon black, glass beads, kaolin clay, talc, mica, glass flake, and graphite can be added. Two or more of these inorganic fillers may be added.

The flame-retardant polybutylene terephthalate resin composition according to the present invention is readily prepared by an apparatus and a method commonly used as the conventional resin composition preparation method. For example, any of (1) to (3) can be used: (1) mixing the respective components, forming pellets of the mixture by kneading and extruding through a single or twin screw extruder, and then preparing the flame-retardant polybutylene terephthalate resin composition; (2) forming pellets having different compositions from each other, being subjected to molding after blending specified amounts of the respective pellets, and then obtaining a molded article having the desired composition; and (3) directly charging one or more of the components to a molding machine. Alternatively, a method in which a portion of the resin components is finely powdered, which is then blended with other components before the addition, is a preferable one for attaining uniform mixture of components.

The electrical or electronic parts or OA equipment parts according to the present invention are preferably any of OA parts guide, OA paper guide, OA gear housing, optical recording media chassis, and electronic parts terminal table.

### EXAMPLES

The present invention is described below in detailed referring to examples. The present invention, however, is not limited to the examples as long as they do not depart from the scope of the invention. The methods for evaluating the characteristics given below are the following.

(1) Tensile Strength

The tensile strength was determined in accordance with ISO 527-1 and 2.

(2) Flammability Test (UL-94)

In accordance with the method of Subject 94 (UL94) of Underwriters Laboratories Inc., the flame-retardancy and the dripping characteristic during resin-combustion were tested through the use of five kinds of test pieces (0.8 mm in thickness).

In accordance with the evaluation method described in UL 94, the flame-retardancy was grouped into the ranks of V-0, V-1, V-2, and notV. For the total combustion time per UL94, the method described in UL 94 was applied, counting the sum of the time (T1) of the first cycle from the ignition to the extinction and the time (T2) of the second cycle from the ignition to the extinction, (T1+T2), as the single test run, and repeating five cycles thereof, thus adopting the total time (seconds) of the five cycles as the total combustion time. Regarding the number of ignited UL 94 cotton pieces, five cycles of test runs were conducted in accordance with the method described in UL 94 by igniting the cotton piece to count the number of cotton pieces ignited resulted from the dripping occurred from above thereof, (the total number of ignited cotton pieces during five test cycles.)

(3) Evaluation of Warpage on the Molding

The molded article in a flat plate shape having 2 mm in thickness and 120 mm×120 mm square was molded under the molding condition given below. The molding was held in an environment of 23° C. of temperature and 50% of humidity for 24 hours or more. Then, the maximum warpage of the flat plate was determined using a height gauge.

### (Molding Condition)

Injection molding machine: SG150U, manufactured by Sumitomo Heavy Industries, Ltd.

Mold: Flat plate (120 mm×120 mm×2 mm)

Cylinder temperature: 260° C.

Injection speed: 1 m/min

Holding pressure: 69 MPa

Mold temperature: 60° C.

(4) Tracking Resistance

In accordance with UL746A, the comparative tracking index (CTI) was determined.

### (Evaluation)

### CTI Rank

0: 600 V or more

1: 400 V or more and less than 600 V

2: 250 V or more and less than 400 V

1: 175 V or more and less than 250 V

(5) Amount of Bleeding of Phosphoric Acid

A flat plate of 0.8 mm in thickness and 13 mm×13 mm square was heated in an oven at 150° C. for 1000 hours. Then, the flat plate was washed on the molding surface thereof by ion-exchanged water. The phosphate ion existing in the washed water was determined by ion chromatography.

### Examples 1 to 13 and Comparative Examples 1 to 11

With the materials having the respective properties listed in Table 3, materials shown in Examples of Table 1 and those shown in Comparative Examples of Table 2 were prepared. The characteristics thereof were evaluated, which are given in the table. The method for preparing the materials is described below.

### <Method for Synthesizing Phosphinic Acid Compound>

### Preparation of Aluminum Salt of 1,2-Diethyl Phosphinic Acid (C-1)

A 2106 g (19.6 mole) of diethyl phosphinic acid was dissolved in 6.5 liter of water. To the mixture, 507 g (6.5 mole) of aluminum hydroxide was added under vigorous agitation, and the mixture was heated to 85° C. The mixture was then agitated at a temperature of 80° C. to 90° C. for 65 hours in total. Then, the mixture was cooled to 60° C. and was treated by suction-filtration. The residue was dried in a vacuum drying cabinet at 120° C. until the mass was constant. 2140 g of fine particle powder was thus obtained, which did not melt at a temperature of 300° C. or less. The yield was 95% of the theoretical value.

### Preparation of Calcium Salt of 1,3-ethane-1,2-bismethyl Phosphinic Acid (C-2)

A 325.5 g (1.75 mole) of ethane-1,2-bismethyl phosphinic acid was dissolved in 500 ml of water. To the mixture, 129.5 g (1.75 mole) of calcium hydroxide was added stepwise for one hour under vigorous agitation. The mixture was then agitated at a temperature of 90° C. to 95° C. for several hours. Then, the mixture was cooled and was treated by suction-filtration. The cake was dried in a vacuum drying cabinet at 150° C. to obtain 335 g of product. The product did not melt at a temperature of 380° C. or less. The yield was 85% of the theoretical value. The resins and the respective components used in Examples and Comparative Examples are shown in Table 3.

<Method for Manufacturing Pellets>

To the polybutylene terephthalate resin of the component (A), specific amounts of components (B), (C), and (E) were added. The mixture was uniformly blended in a V-blender. Thus obtained mixture was supplied to a twin screw extruder (30 mm φ in diameter) while adding a specified amount of glass fiber (D) by main-feed or side-feed, thus melting and mixing them at barrel temperature of 260° C., followed by cooling and cutting the strands extruded from the die, and obtained the pellets.

TABLE 1

| | | Examples | | | | | | | | | | | | |
|---|---|---|---|---|---|---|---|---|---|---|---|---|---|---|
| | | 1 | 2 | 3 | 4 | 5 | 6 | 7 | 8 | 9 | 10 | 11 | 12 | 13 |
| (A) | A-1 (parts by weight) | 100 | 100 | 100 | 100 | 100 | 100 | 100 | 100 | 100 | 100 | 100 | 100 | 100 |
| (B) | B-1 (parts by weight) | 42 | 42 | 42 | | | | | | | | 19 | | |
| | B-2 (parts by weight) | | | | 27 | | | | | | | | | |
| | B-3 (parts by weight) | | | | | 54 | 54 | 78 | 54 | 73 | 73 | | 28 | 28 |
| (C) | C-1 (parts by weight) | 45 | | 68 | 41 | 49 | 49 | 57 | 49 | 59 | 59 | 40 | 39 | 47 |
| | C-2 (parts by weight) | | 45 | | | | | | | | | | | |
| (D) | D-1 (parts by weight) | | | | | | 98 | 114 | | | 59 | | | |
| | D-2 (parts by weight) | | | | | | | | 98 | | | | | |
| | D-3 (parts by weight) | 91 | 91 | 91 | | 98 | | | | | | | | |
| | D-4 (parts by weight) | | | | 81 | | | | | 117 | 59 | 81 | 79 | 79 |
| (E) | E-1 (parts by weight) | 23 | 23 | | 20 | 25 | 25 | 28 | 25 | 29 | 29 | 20 | 8 | |
| Evaluation | UL94; Fire-retardant class | V-0 | V-0 | V-0 | V-0 | V-0 | V-0 | V-0 | V-0 | V-0 | V-0 | V-0 | V-0 | V-0 |
| | UL94; Total combustion time (sec) | 44 | 46 | 40 | 40 | 18 | 18 | 33 | 15 | 13 | 14 | 18 | 23 | 25 |
| | UL94; The number of test pieces flaming | 0 | 0 | 0 | 0 | 0 | 0 | 0 | 0 | 0 | 0 | 0 | 0 | 0 |
| | for 10 sec or more | | | | | | | | | | | | | |
| | UL94; The number of cotton pieces ignite | 0 | 0 | 0 | 0 | 0 | 0 | 0 | 0 | 0 | 0 | 0 | 0 | 0 |
| | Warpage (mm) | 12 | 12 | 10 | 6 | 12 | 15 | 10 | 12 | 1 | 11 | 4 | 2 | 2 |
| | Tensile strength (Mpa) | 81 | 85 | 83 | 88 | 97 | 103 | 92 | 97 | 96 | 93 | 87 | 107 | 107 |
| | Bleeding amount of phosphate ion | <0.1 | <0.1 | <0.1 | <0.1 | <0.1 | <0.1 | <0.1 | <0.1 | <0.1 | <0.1 | <0.1 | <0.1 | <0.1 |
| | (μg/mm²) | | | | | | | | | | | | | |
| | UL746A CTI rank | 0 | 0 | 0 | 0 | 0 | 0 | 0 | 0 | 0 | 0 | 0 | 0 | 0 |

TABLE 2

| | | Comparative Examples | | | | | | | | | | |
|---|---|---|---|---|---|---|---|---|---|---|---|---|
| | | 1 | 2 | 3 | 4 | 5 | 6 | 7 | 8 | 9 | 10 | 11 |
| (A) | A-1 (parts by weight) | 100 | 100 | 100 | 100 | 100 | 100 | 100 | 100 | 100 | 100 | 100 |
| (A′) | A′-1 (parts by weight) | | | | | | | | | 54 | | |
| (B) | B-1 (parts by weight) | | | | 42 | | | | | | | 27 |
| | B-2 (parts by weight) | | | | | | | | | 18 | | 27 |
| | B-3 (parts by weight) | | | 27 | | 43 | 28 | | | | | |
| (B′) | B′-1 (parts by weight) | | | | | | | | 59 | | | |
| | B′-2 (parts by weight) | | | | | | | 43 | | 54 | | |
| (C) | C-1 (parts by weight) | 32 | 32 | 41 | 45 | 43 | | 43 | | | | |
| (C′) | C′-1 (parts by weight) | | | | | | | | 13 | | | |
| | C′-2 (parts by weight) | | | | | | | | | 63 | | |
| | C′-3 (parts by weight) | | | | | | | | | | 22 | 24 |
| | C′-4 (parts by weight) | | | | | | | | | | 15 | 16 |
| (D) | D-1 (parts by weight) | 64 | | | | | | 86 | 92 | | 58 | 43 |
| | D-2 (parts by weight) | | | | | | | | | | | |
| | D-3 (parts by weight) | | 64 | | | | | | | | | |
| | D-4 (parts by weight) | | | | | | 79 | | | | | |
| (D′) | D′-1 (parts by weight) | | | 81 | 91 | 86 | | | | 136 | | |
| | D′-2 (parts by weight) | | | | | | | | | | | 43 |
| (E) | E-1 (parts by weight) | 16 | 16 | 20 | 23 | 22 | 47 | 22 | | 23 | | |
| Evaluation | UL94: Fire-retardant class | V-0 | V-0 | V-1 | V-1 | V-1 | notV | V-0 | V-0 | V-0 | V-0 | V-0 |
| | UL94: Total combustion time (sec) | 37 | 20 | 84 | 83 | 67 | 227 | 33 | 18 | 16 | 10 | 15 |
| | UL94; The number of test pieces flaming | 0 | 0 | 4 | 5 | 2 | 5 | 0 | 0 | 0 | 0 | 0 |
| | for 10 sec or more | | | | | | | | | | | |
| | UL94: The number of cotton pieces ignited | 0 | 0 | 0 | 0 | 0 | 5 | 0 | 0 | 0 | 0 | 0 |
| | Warpage (mm) | 25 | 20 | 24 | 7 | 11 | 2 | 17 | 10 | 6 | 25 | <1 |
| | Tensile strength (MPa) | 100 | 95 | 90 | 85 | 103 | 112 | 83 | 130 | 110 | 140 | 95 |
| | Bleeding amount of phosphate ion (μg/mm²) | <0.1 | <0.1 | <0.1 | <0.1 | <0.1 | <0.1 | <0.1 | 7.5 | 1.3 | <0.1 | <0.1 |
| | (μg/mm²) | | | | | | | | | | | |
| | UL745A CTI rank | 0 | 0 | 0 | 1 | 1 | 0 | 2 | 3 | 3 | 2 | 2 |

TABLE 3

| | | |
|---|---|---|
| (A) | A-1 | Polybutylene terephthalate giving IV = 0.8: |
| | | manufactured by WinTech Polymer Ltd. |
| (A′) | A′-1 | Polyethylene terephthalate giving IV = 0.7: |
| | | manufactured by Teijin Fiber Co., Ltd. |
| (B) | B-1 | ABS resin |
| | B-2 | ESBS resin |
| | B-3 | 12.5 mol % Isophthalic acid-modified |
| | | polyethylene terephthalate |
| (B′) | B′-1 | Polycarbonate |
| | B′-2 | Polyphenylene ether |
| (C) | C-1 | Aluminum salt of 1,2-diethyl phosphinic acid |
| | C-2 | Calcium salt of 1,3-ethane-1,2-bismethyl |
| | | phosphinic acid |
| (C′) | C′-1 | Red phosphorus NVE140: manufactured by |
| | | RINKAGAKU KOGYO CO., LTD. |
| | C′-2 | Phosphoric acid ester PX-200: manufactured by |
| | | DAIHACHI CHEMICAL INDUSTRY CO., LTD. |
| | C′-3 | Brominated epoxy SRT5000: manufactured by |
| | | Sakamoto Yakuhin Kogyo Co., Ltd. |
| | C′-4 | Antimony trioxide PATIOX-M: manufactured by |
| | | Nihon Seiko Co., Ltd. |
| (D) | D-1 | Glass fiber having 133 μm 2 of average cross- |
| | | sectional area and having 1.0 of a ratio |
| | | of major axis to minor axis, CS3PE941: |
| | | manufactured by Nitto Boseki Co., Ltd. |
| | D-2 | Glass fiber having 201 μm 2 of average cross- |
| | | sectional area and having 1.0 of a ratio |
| | | of major axis to minor axis, CS3QA948S: |
| | | manufactured by Nitto Boseki Co., Ltd. |
| | D-3 | Glass fiber having 176 μm 2 of average cross- |
| | | sectional area and having 2.0 of a ratio |
| | | of major axis to minor axis, CSH3PA860: |
| | | manufactured by Nitto Boseki Co., Ltd. |
| | D-4 | Glass fiber having 176 μm 2 of average cross- |
| | | sectional area and having 4.0 of a ratio |
| | | of major axis to minor axis, CSG3PA830: |
| | | manufactured by Nitto Boseki Co., Ltd. |
| (D′) | D′-1 | Glass fiber having 95 μm 2 of average cross- |
| | | sectional area and having 1.0 of a ratio |
| | | of major axis to minor axis, CS3J948: |
| | | manufactured by Nitto Boseki Co., Ltd. |
| | D′-2 | Glass flake PEFG-108: manufactured by |
| | | Nippon Sheet Glass Company, Limited. |
| (E) | F-1 | Melamine cyanulate MC50: manufactured by |
| | | Chiba Specialty Chemicals Co., Ltd. |

1. A flame-retardant polybutylene terephthalate resin composition comprising: (A) 100 parts by weight of a polybutylene terephthalate-based resin; (B) 10 to 100 parts by weight of one or more types of polymer selected from a modified polyester and a styrene-based resin; (C) 10 to 100 parts by weight of a phosphinic acid salt expressed by the formula (1) and/or a diphosphinic acid salt expressed by the formula (2) and/or a polymer thereof; and (D) 20 to 200 parts by weight of glass fiber having 100 to 300 square micrometers of the average cross-sectional area, 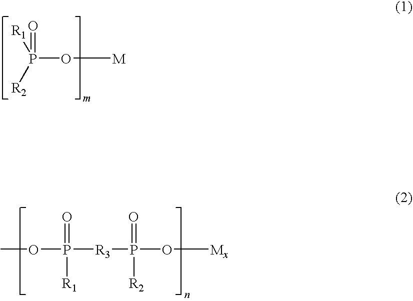
(where R₁ and R₂ are each a straight-chain or branched-chain C₁ to C₆ alkyl or phenyl, R₃ is a straight-chain or branched-chain C₁ to C₁₀ alkylene, arylene, alkylarylene, or arylalkylene, M is calcium ion or aluminum ion, m is 2 or 3, n is 1 or 3, and X is 1 or 2.)

2. The flame-retardant polybutylene terephthalate resin composition according to claim 1, wherein the average cross-sectional area of the (D) glass fiber is 140 to 300 square micrometers.

3. The flame-retardant polybutylene terephthalate resin composition according to claim 1, wherein the (D) glass fiber has a flat cross section giving a ratio of the longer diameter on the cross section perpendicular to the longitudinal direction (major axis, the longest linear distance across the section) to the shorter diameter (minor axis, the longest linear distance perpendicular to the longer diameter) within a range of 1.3 to 10.

4. The flame-retardant polybutylene terephthalate resin composition according to claim 1, giving the flame-retardancy of V-0 rank with a thickness of 1 mm or less, per UL Standard UL 94.

5. The flame-retardant polybutylene terephthalate resin composition according to claim 1, wherein the modified polyester as the (B) component has a modification rate of 10% by mole or more to the total amount of dicarboxylic acid.

6. The flame-retardant polybutylene terephthalate resin composition according to claim 1, further comprising (E) a triazine-based compound and a salt of cyanulic acid or isocyanulic acid.

7. The flame-retardant polybutylene terephthalate resin composition according to claim 6, wherein the blending amount of the (E) triazine-based compound and the salt of cyanulic acid or isocyanulic acid is 5 to 50% by weight to the total amount of the (C) component and the (E) component, and the total amount of the (C) component and the (E) component is 10 to 100 parts by weight to 100 parts by weight of the (A) component.

8. Electrical or electronic parts or OA equipment parts being manufactured by injection molding of the flame-retardant polybutylene terephthalate resin composition according to claim 1.

9. The electrical or electronic parts or OA equipment parts according to claim 8 being any of OA parts guide, OA paper guide, OA gear housing, optical recording media chassis, and electronic parts terminal table.

10. The flame-retardant polybutylene terephthalate resin composition according to claim 2, giving the flame-retardancy of V-0 rank with a thickness of 1 mm or less, per UL Standard UL 94.

11. The flame-retardant polybutylene terephthalate resin composition according to claim 3, giving the flame-retardancy of V-0 rank with a thickness of 1 mm or less, per UL Standard UL 94.

12. The flame-retardant polybutylene terephthalate resin composition according to claim 2, wherein the modified polyester as the (B) component has a modification rate of 10% by mole or more to the total amount of dicarboxylic acid.

13. The flame-retardant polybutylene terephthalate resin composition according to claim 3, wherein the modified polyester as the (B) component has a modification rate of 10% by mole or more to the total amount of dicarboxylic acid.

14. The flame-retardant polybutylene terephthalate resin composition according to claim 4, wherein the modified polyester as the (B) component has a modification rate of 10% by mole or more to the total amount of dicarboxylic acid.

15. The flame-retardant polybutylene terephthalate resin composition according to claim 2, further comprising (E) a triazine-based compound and a salt of cyanulic acid or isocyanulic acid.

16. The flame-retardant polybutylene terephthalate resin composition according to claim 3, further comprising (E) a triazine-based compound and a salt of cyanulic acid or isocyanulic acid.

17. The flame-retardant polybutylene terephthalate resin composition according to claim 4, further comprising (E) a triazine-based compound and a salt of cyanulic acid or isocyanulic acid.

18. The flame-retardant polybutylene terephthalate resin composition according to claim 5, further comprising (E) a triazine-based compound and a salt of cyanulic acid or isocyanulic acid.

19. Electrical or electronic parts or OA equipment parts being manufactured by injection molding of the flame-retardant polybutylene terephthalate resin composition according to claim 2.

20. Electrical or electronic parts or OA equipment parts being manufactured by injection molding of the flame-retardant polybutylene terephthalate resin composition according to claim 3.
